(19) United States
(12) Patent Application Publication
(10) Pub. No.: US 2022/0240747 A1
(43) Pub. Date: Aug. 4, 2022

(54) BUBBLE GENERATION APPARATUS AND WASHING DEVICE

(71) Applicants: FOSHAN SHUNDE MIDEA WASHING APPLIANCES MANUFACTURING CO., LTD., FOSHAN (CN); MIDEA GROUP CO., LTD., FOSHAN (CN)

(72) Inventors: Jie GENG, FOSHAN (CN); Pingping XU, FOSHAN (CN); Xiang LI, FOSHAN (CN); Manhua PENG, FOSHAN (CN); Shi HUANG, FOSHAN (CN)

(21) Appl. No.: 17/630,510

(22) PCT Filed: Aug. 3, 2020
(86) PCT No.: PCT/CN2020/106617

§ 371 Date: Jan. 27, 2022

(30) Foreign Application Priority Data
Aug. 2, 2019 (CN) 201910713400.X
Aug. 2, 2019 (CN) 201912251533.1
Jul. 31, 2020 (CN) 202010761606.2
Jul. 31, 2020 (CN) 202021576757.2

(51) Int. Cl. A47L 15/42; B01F 23/231; B01F 23/232; B01F 25/312; B01F 25/10

(52) U.S. Cl. CPC A47L 15/4214; B01F 23/231; B01F 23/232; B01F 2025/914; B01F 25/101; B01F 25/103; B01F 2215/0422; B01F 25/3121

(57) ABSTRACT

Provided are a bubble generation apparatus and a washing device, the bubble generation apparatus includes a gas dissolution chamber, a bypass member, and a bubbler. The gas dissolution chamber has a vent opening, a liquid inlet, and a liquid outlet, the bypass member has a gradually contracting section, a throat part, and a gradually expanding section which are connected in sequence from a bypass inlet to a bypass outlet; the bubbler is connected to the liquid outlet, the bypass inlet or bypass outlet of the bypass member is connected to the liquid inlet to supply liquid into the gas dissolution chamber, and the throat part is connected to the vent opening or a gas storage space in the gas dissolution chamber.

### CROSS-REFERENCES TO RELATED APPLICATIONS

The present disclosure is a national phase application of International Application No. PCT/CN2020/106617, filed on Aug. 3, 2020, which claims priority to Chinese Patent Applications Serial No. 201910713400.X and 201921251533.1, filed on Aug. 2, 2019, and to Chinese Patent Applications Serial No. 202010761606.2 and 202021576757.2, filed on Jul. 31, 2020, the entireties of which are herein incorporated by reference.

### FIELD

The present disclosure relates to the field of cleaning technology, in particular to a bubble generating device and a washing apparatus with the same.

### BACKGROUND

Dishwashers are machines that use chemical, mechanical, thermal and electrical processes to wash, rinse and dry tableware such as bowls, plates, glassware, cutlery and cooking vessels and the like.

At present, household dishwashers all use a water spray cleaning process. However, on one hand, it is difficult for such water spray dishwashers to clean common Chinese tableware due to the problem with the water spray angle. On the other hand, the cleaning effect of the water spray dishwashers is always unsatisfactory due to the short contact time between the ejected cleaning liquid and tableware. In view of this, water spray dishwashers have not been popularized in Chinese households.

### SUMMARY

One embodiment of the present disclosure provides a bubble generating device, which can improve a bubble generation rate.

Another embodiment of the present disclosure provides a washing apparatus with the bubble generating device.

The bubble generating device according to an embodiment of the present disclosure includes a gas dissolution chamber, a bypass member and a bubbler. The gas dissolution chamber has a vent, a liquid inlet and a liquid outlet. The bypass member has a convergent section, a throat section and a divergent section connected in sequence from a bypass inlet to a bypass outlet. The bubbler is connected to the liquid outlet. The bypass inlet or the bypass outlet of the bypass member is communicated with the liquid inlet to supply a liquid into the gas dissolution chamber. The throat section is communicated with the vent or a gas storage space in the gas dissolution chamber.

With the bubble generating device according to the embodiment of the present disclosure, the bubble generation rate can be improved.

In addition, the bubble generating device according to the above embodiments of the present disclosure may also have the following additional features.

In one embodiment, the throat section is communicated with the vent and the outlet of the bypass member is communicated with the liquid inlet of the gas dissolution chamber to form a circulation loop.

In one embodiment, at least a part of the gas dissolution chamber is a rotary housing, and the liquid inlet and the liquid outlet are both connected to the rotary housing.

In one embodiment, the liquid inlet and the liquid outlet both extend away from the gas dissolution chamber in a clockwise direction or a counterclockwise direction of the rotary housing.

In one embodiment, an angle between a liquid feeding direction of the liquid inlet and a liquid discharging direction of the liquid outlet is not greater than 90°.

In one embodiment, one of the liquid inlet and the liquid outlet extends away from the gas dissolution chamber in a clockwise direction thereof, and the other of the liquid inlet and the liquid outlet extends away from the gas dissolution chamber in a counterclockwise direction thereof.

In one embodiment, an angle between a liquid feeding direction of the liquid inlet and a liquid discharging direction of the liquid outlet is greater than 90°.

In one embodiment, an angle between the liquid feeding direction of the liquid inlet and the liquid discharging direction of the liquid outlet is in the range of 120° to 180°.

In one embodiment, the liquid inlet and the liquid outlet both extend in a tangential direction of the rotary housing.

In one embodiment, the vent is arranged at a top of the gas dissolution chamber, and the liquid inlet and the liquid outlet are arranged at a lower part of the gas dissolution chamber.

In one embodiment, the lower part of the gas dissolution chamber is in a shape of a barrel.

In one embodiment, an upper part of the gas dissolution chamber is in a shape that gradually shrinks in a bottom-up direction.

In one embodiment, the liquid inlet and the liquid outlet are arranged on opposite sides of a plane passing through a centerline of the gas dissolution chamber.

In one embodiment, the liquid inlet and the liquid outlet are respectively arranged at different walls of the gas dissolution chamber.

In one embodiment, the liquid inlet is higher than the liquid outlet.

In one embodiment, the bubble generating device further includes a venting valve, and one end of the venting valve is communicated with the vent.

In one embodiment, the bubble generating device further includes a gas pump, and two ends of the venting valve are respectively connected to the vent of the gas dissolution chamber and the gas pump.

In one embodiment, the bypass member is arranged in the gas dissolution chamber, and the bypass inlet is communicated with the liquid inlet, the bypass outlet is communicated with an inner space of the gas dissolution chamber, and the throat section is communicated with the gas storage space.

In one embodiment, the gas storage space is arranged at the top of the gas dissolution chamber.

In one embodiment, a horizontal cross-sectional area of the gas storage space is less than a horizontal cross-sectional area of a space below the gas storage space.

In one embodiment, the bypass member is arranged in the lower part of the gas dissolution chamber, a connecting pipe is connected and communicated with the throat section of the bypass member, and extends upward to approach or access the gas storage space.

In one embodiment, a reinforcing rib is arranged in the gas dissolution chamber, and divides the gas dissolution chamber into transverse channels communicated with each other, the transverse channels extend in a horizontal direction, and transverse channels are sequentially arranged in an up-down direction.

In one embodiment, transverse channels include a first transverse channel, a second transverse channel, a third transverse channel, and a fourth transverse channel in a top-down direction, in which the first transverse channel is located in the gas storage space, the liquid is supplied from the liquid inlet to the third transverse channel, and the liquid outlet is communicated with the fourth transverse channel.

In one embodiment, the bypass outlet is opposite to the third transverse channel, and a liquid discharging direction of the bypass outlet is parallel to an extension direction of the third transverse channel.

In one embodiment, the vent is positioned near the first transverse channel.

In one embodiment, a distance between the second transverse channel and the third transverse channel is greater than that between the first transverse channel and the second transverse channel, and greater than that between the third transverse channel and the fourth transverse channel.

In one embodiment, the liquid outlet is arranged at a bottom wall of the fourth transverse channel.

In one embodiment, the gas dissolution chamber is divided into longitudinal channels by the reinforcing rib, longitudinal channels are arranged at intervals in a horizontal direction, the longitudinal channels extend in an up-down direction, and intersect the transverse channels in the up-down direction, and the longitudinal channels and the transverse channels are interlaced and communicated with each other.

In one embodiment, the bubble generating device further includes a venting valve, which is connected to the vent, and configured to allow unidirectional flow of a gas stream toward the inner space of the gas dissolution chamber.

In one embodiment, the gas dissolution chamber is in a flat shape.

In one embodiment, the wall thickness of the gas dissolution chamber is in the range of 2 mm to 5 mm.

In one embodiment, the gas dissolution chamber includes a first shell and a second shell fastened and fixedly connect to each other.

In one embodiment, bumps are respectively provided at a periphery of the first shell and a periphery of the second shell, and the bumps on the first shell are correspondingly connected with the bumps on the second shell to connect the periphery of the first shell with the periphery of the second shell.

In one embodiment, a fixing block is arranged in a middle of the gas dissolution chamber, and the fixing block is used for fixing piece connection to connect a middle of the first shell with a middle of the second shell.

A washing apparatus according to another embodiment of the present disclosure includes the bubble generating device according to the aforementioned embodiments.

In one embodiment, the washing apparatus further includes a body and a door. The body has a washing cavity therein. The door is disposed on the body and configured to open or close the washing cavity. The bubble generating device is provided on at least one of a side wall of the body, a top wall of the body, a bottom wall of the body and the door.

### BRIEF DESCRIPTION OF THE DRAWINGS

FIG. 1 is a schematic diagram of a bubble generating device in an embodiment of the present disclosure.

FIG. 2 is a schematic view of a bypass member (Venturi tube) in a bubble generating device in an embodiment of the present disclosure.

FIG. 3 is a schematic view of a bypass member (partial structure of a jet pump) in a bubble generating device in an embodiment of the present disclosure.

FIG. 4 is a schematic view of a gas dissolution chamber of a bubble generating device in an embodiment of the present disclosure.

FIG. 5 is a sectional view of FIG. 4.

FIG. 6 is a schematic view of a gas dissolution chamber of a bubble generating device in an embodiment of the present disclosure.

FIG. 7 is a sectional view of FIG. 6.

FIG. 8 is a schematic view of a gas dissolution chamber of a bubble generating device in an embodiment of the present disclosure.

FIG. 9 is a sectional view of FIG. 8.

FIG. 10 is a schematic diagram of a bubble generating device in an embodiment of the present disclosure.

FIG. 11 is a sectional view of a gas dissolution chamber of a bubble generating device in an embodiment of the present disclosure.

FIG. 12 is a sectional view of a gas dissolution chamber of a bubble generating device in an embodiment of the present disclosure.

FIG. 13 is a schematic diagram of a washing apparatus in an embodiment of the present disclosure.

FIG. 14 is a schematic diagram of a bubble generating device in another embodiment of the present disclosure.

FIG. 15 is a schematic view of a washing apparatus in an embodiment of the present disclosure.

Reference numerals: washing apparatus 1000, bubble generating device 100, gas dissolution chamber 1, vent 101, liquid inlet 102, liquid outlet 103, liquid feeding direction A of liquid inlet 102, liquid discharging direction B of liquid outlet 103, bypass member 2, convergent section 21, throat section 22, divergent section 23, bubbler 3, liquid feeding valve 4, first transverse channel 1041, second transverse channel 1042, third transverse channel 1043, fourth transverse channel 1044, longitudinal channel 106, first shell 11, second shell 12, gas dissolution cavity 105, bypass inlet 201, bypass outlet 202, reinforcing rib 13, gas pump 5, venting valve 6, bump 107, fixing block 108, body 200.

### DETAILED DESCRIPTION OF THE DISCLOSURE

Microbubbles have the characteristics of charged adsorption, detergent solubilization, and mechanical vibration caused by bubble collapse and the like. This technology may provide help for detergent dissolution, degreasing, pesticide residue removal of fruits and vegetables, pollutant filtration, etc., and improve the cleaning rate. Microbubble generation technology can be divided into: electrolysis, ultrasonic cavitation, throttling cavitation, low-pressure suction and the like. Among them, increasing the pressure can increase the dissolution rate of gas in a liquid and increase the concentration of bubbles generated by a throttling cavitation process.

Embodiments of the present disclosure provides a device for producing microbubbles by utilizing the energy of a washing pump, which can utilize the microbubbles to participate in the washing process of a washing apparatus. The washing apparatus in embodiments of the present disclosure can be a cleaning apparatus including a dishwasher.

Embodiments of the present disclosure will be described below in detail, examples of which are shown in the drawings, in which the same or similar elements or elements having the same or similar functions are denoted by the same or similar reference numerals throughout the description. The embodiments described below with reference to drawings are explanatory and intended to explain the present disclosure, but should not be construed to limit the present disclosure.

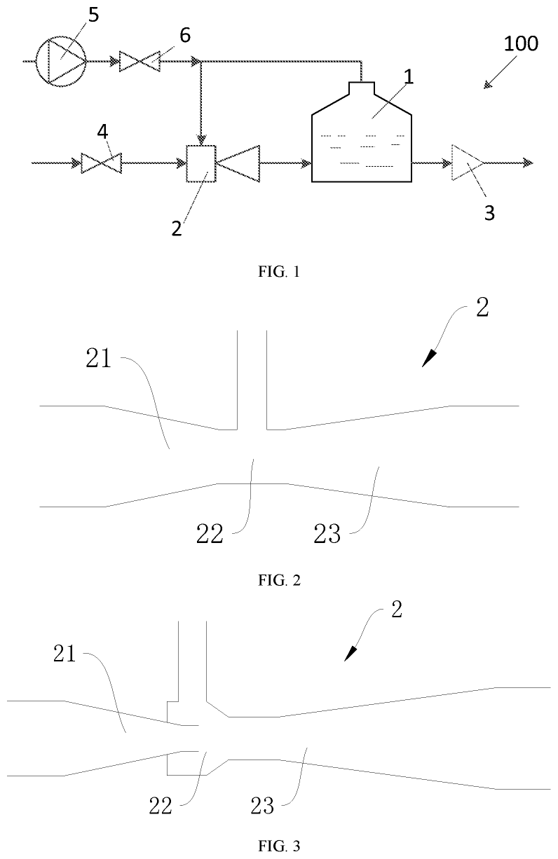

Referring to FIG. 1 to FIG. 5, a bubble generating device 100 according to an embodiment of the present disclosure includes a gas dissolution chamber 1 and a bubbler 3. Gas and a liquid can be mixed in the gas dissolution chamber 1, and then bubbles are generated by the bubbler 3 to form a liquid with bubbles.

In one embodiment, the gas dissolution chamber 1 has a vent 101, a liquid inlet 102 and a liquid outlet 103. The gas can enter into the gas dissolution chamber 1 via the vent 101, and the liquid can enter into the gas dissolution chamber 1 via the liquid inlet 102, and the gas and liquid entering into the gas dissolution chamber 1 can be mixed, an amount of gas is mixed into the liquid to complete the gas dissolution. The bubbler 3 is connected to the liquid outlet 103. In other words, a gas-liquid mixed fluid in a gas dissolution cavity 105 enters into the bubbler 3 via the liquid outlet 103, and the function of the bubbler 3 is to cause the gas in the gas-liquid mixed fluid to be dispersed to form bubbles, thus forming a large number of tiny bubbles in the liquid.

With the bubble generating device 100 according to the embodiment of the present disclosure, since the liquid is mixed in the gas dissolution cavity 105 before entering the bubbler 3, the more gas dissolved in the liquid when passing through the bubbler 3, the more quickly bubbles will be generated through the bubbler 3, and when there is enough gas dissolved in the liquid, more bubbles will be generated when the liquid passes through the bubbler 3, finally achieving the purpose of increasing the bubble generation rate.

It should be noted that the bubbler in embodiments of the present disclosure is used to generate bubbles in the fluid in use. In one embodiment, due to the bubbler 5 has a throttling effect, the water feeding velocity of the gas dissolution chamber 3 is greater than the water discharging velocity, and the pressure of the gas dissolution chamber 3 is continuously increased (a dynamic pressure of liquid flowing is continuously converted into a static pressure of a medium in the gas dissolution chamber during this process), thus causing more gas to be incorporated into the liquid. When the gas solution flows to the bubbler 5, during the throttling process, the overflow cross-sectional area is continuously reduced, the flow rate increases, the pressure decreases, and the gas is continuously evolved by cavitation, to generate a large number of microbubbles.

In addition, the gas dissolution chamber 1 has the gas dissolution cavity 105, and the vent 101, the liquid inlet 102 and the liquid outlet 103 are all communicated with the gas dissolution cavity 105.

As mentioned above, in order to achieve the purpose of generating more bubbles, it is necessary to dissolve more gas into the liquid, and the dissolution of more gas into the liquid can be promoted by reducing the pressure of the liquid, increasing the flow rate of the liquid, and increasing the internal pressure of the gas dissolution cavity 105 and so on. As an example, a liquid feeding direction of the liquid inlet 102 is intersected with a gas feeding direction of the vent 101, and when the liquid enters the gas dissolution cavity 105 via the liquid inlet 102, it immediately mixes with the gas introduced from the vent 101. This is because once the liquid enters the gas dissolution cavity 105, the liquid will enter into the gas dissolution cavity 105 with a larger size from the liquid inlet 102 with a smaller size, the pressure of the liquid is lower, and the gas dissolving rate is higher. As another example, the gas dissolving rate can be improved by increasing the flow rate of the fluid, for example, according to Bernoulli's principle, when the flow rate of the fluid is relatively large, the pressure of the fluid will decrease, and the gas dissolving rate is relatively high, thus effectively improving the gas dissolving rate. Of course, other processes for improving the gas dissolving rate can also be used in embodiments of the present disclosure, for example, pressurizing the gas dissolution cavity 105 and the like. Some processes for improving the gas dissolving rate in embodiments of the present disclosure are described below.

In some embodiments of the present disclosure, the bubble generating device 100 further includes a bypass member 2. The bypass member 2 has a bypass inlet 201 and a bypass outlet 202, and includes a convergent section 21, a throat section 22 and a divergent section 23 connected in sequence from the bypass inlet 201 to the bypass outlet 202. In other words, the convergent section 21, the throat section 22 and the divergent section 23 are arranged in sequence between the bypass inlet 201 of the bypass member 2 and the bypass outlet 202 of the bypass member 2. A convergent tube shrinks from the bypass inlet 201 of the bypass member 2 toward the throat section 22, and the divergent section 23 is communicated with the throat section 22 and expands to the bypass outlet 202 in a direction away from the throat section 22. The bypass inlet or the bypass outlet of the bypass member is communicated with the liquid inlet to supply a liquid into the gas dissolution chamber, and the throat section is communicated with the vent or a gas storage space in the gas dissolution chamber.

With the bubble generating device 100 according to the embodiment of the present disclosure, the gas dissolving rate in the liquid is effectively improved, to improve the efficiency and effect of bubble generation.

In some embodiments of the present disclosure, the throat section 22 is communicated with the vent 101, and an outlet of the bypass member 2 is communicated with the liquid inlet of the gas dissolution chamber 1. In this way, the liquid can flow into the gas dissolution chamber 1 via the bypass member, and a part of the gas in the liquid flowing into the gas dissolution chamber 1 from the bypass member will be released into the gas dissolution chamber, while the gas in the gas dissolution chamber 1 (including the gas originally existing in the gas dissolution chamber and a part of the gas released from the liquid flowing into the gas dissolution chamber from the bypass member) can also flow into the throat section 22 via the vent 101 to form a circulation structure.

The bypass member 2 has an inlet and the outlet, the convergent tube 21 shrinks from the inlet of the bypass member 2 toward the throat section 22, the divergent section 23 is communicated with the throat section 22 and expands to the outlet in a direction away from the throat section 22, and the outlet of the bypass member 2 can be communicated with the gas dissolution chamber 1. The bubbler 3 is connected with the liquid outlet 103 of the gas dissolution chamber 1, and disperses the liquid with the dissolved gas in the gas dissolution chamber 1 to form a liquid with bubbles.

When the liquid passes through the bypass member 2, due to the shape of the bypass member 2, the liquid can flow at high speed and low pressure in the bypass member 2, the gas in the gas dissolution chamber 1 is sucked into the bypass member 2 via the vent 101 to form a gas-liquid mixed fluid, and then enters into the gas dissolution cavity of the gas dissolution chamber 1, and the liquid is subjected to further gas-liquid mixing in the gas dissolution chamber. In the gas dissolution chamber, a part of the gas in the liquid follows the liquid into the bubbler to generate bubbles, while another part of the gas in the liquid may evolve into an upper part of the gas dissolution chamber and flow to the bypass member 2 again. After the liquid passes through the bubbler 3, a liquid with a large number of bubbles is generated.

Of course, the gas entering the bypass member from the vent can also be completely dissolved in the liquid, and all follow the liquid into the bubbler to generate bubbles.

With the bubble generating device 100 according to the embodiment of the present disclosure, the gas dissolving rate in the liquid is effectively improved, to improve the efficiency and effect of bubble generation.

Therefore, through the bubble generating device 100 according to the embodiment of the present disclosure, a liquid carrying a large number of bubbles can be generated, and when the liquid participates in the washing process, the effect of the washing will be improved under the action of the bubbles.

In one embodiment, at least a part of the gas dissolution chamber 1 is a rotary housing. The rotary housing refers to a housing rotated around a fixed axis. In embodiments of the present disclosure, the liquid inlet 102 and the liquid outlet 103 are both connected to the rotary housing.

After the liquid enters into the gas dissolution chamber through the liquid inlet, due to the liquid has kinetic energy, a vortex fluid may be formed in the rotary housing, which increases the gas dissolving rate in the liquid and enables large bubbles in the fluid to evolve to avoid affecting the quality of the bubbles generated by the bubble generator, to increase the number of bubbles and reducing the size of the generated bubbles.

In one embodiment, both the liquid inlet 102 and the liquid outlet 103 extend away from the gas dissolution chamber 1 in a clockwise direction of the rotary housing, the liquid feeding direction A of the liquid inlet 102 extends in a counterclockwise direction of the rotary housing, and the liquid discharging direction B of the liquid outlet 103 extends in a clockwise direction of the gas dissolution chamber 1. Therefore, after the liquid entering into the gas dissolution chamber 1 from the liquid inlet 102, it needs to flow in an approximately S direction, and then is sent out from the liquid outlet 103. Thus, the liquid entering the gas dissolution chamber 1 can undergo a better flow perturbation effect, to improve the efficiency and effect of gas dissolution.

In addition, the liquid inlet 102 and the liquid outlet 103 can also be arranged to extend away from the gas dissolution chamber 1 in the counterclockwise direction of the rotary housing, since this arrangement is similar to the aforementioned arrangement, the working principles of the two arrangements are relatively similar, and thus this arrangement will not be elaborated here.

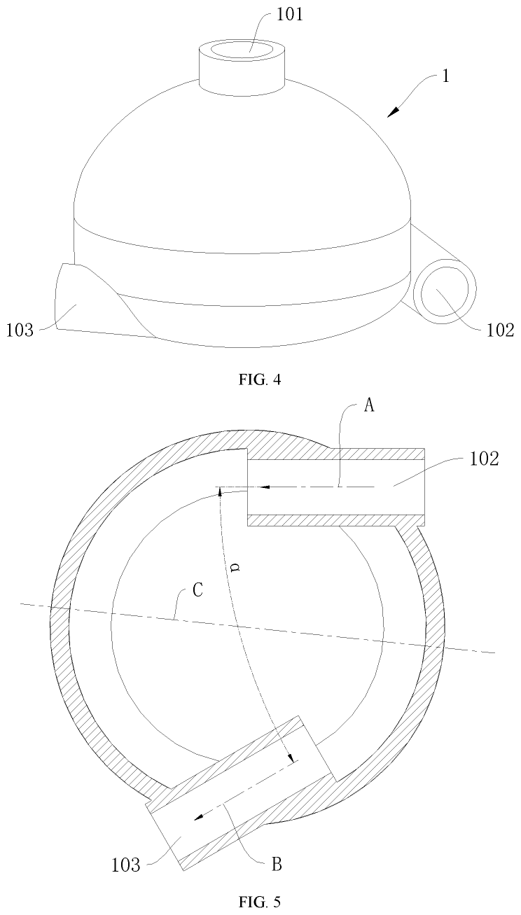

It can be seen from FIG. 4 and FIG. 5 that an angle between the liquid feeding direction and the liquid discharging direction determines a distance between the liquid inlet 102 and the liquid outlet 103. When the angle between the liquid feeding direction and the liquid discharging direction is larger (for example, greater than 90°), the distance between the liquid inlet 102 and the liquid outlet 103 will be reduced. For example, when the angle between the liquid inlet 102 and the liquid outlet 103 reaches 180°, the liquid inlet 102 and the liquid outlet 103 will coincide. Therefore, the angle between the liquid feeding direction and the liquid discharging direction can be set to be small enough so there is a relatively suitable distance between the liquid inlet 102 and the liquid outlet 103, to improve the gas absorbed by a feeding liquid in the gas dissolution chamber 1. For example, when the angle between the liquid feeding direction and the liquid discharging direction is set to 0°, there is a larger distance between the liquid inlet 102 and the liquid outlet 103, and the liquid entering the gas dissolution chamber 1 needs to pass through a roughly S flow path and then is sent out from the liquid outlet 103.

In one embodiment, the angle α between the liquid feeding direction A of the liquid inlet 102 and the liquid discharging direction B of the liquid outlet 103 is not greater than 90°. The flow from the liquid inlet 102 to the liquid outlet 103 changes through a relatively large angle, which effectively improves the gas dissolving effect of the liquid in the gas dissolution chamber 1.

Of course, the angle α between the liquid feeding direction A of the liquid inlet 102 and the liquid discharging direction B of the liquid outlet 103 in embodiments of the present disclosure can also be greater than 90°, and a better gas dissolving effect can also be achieved.

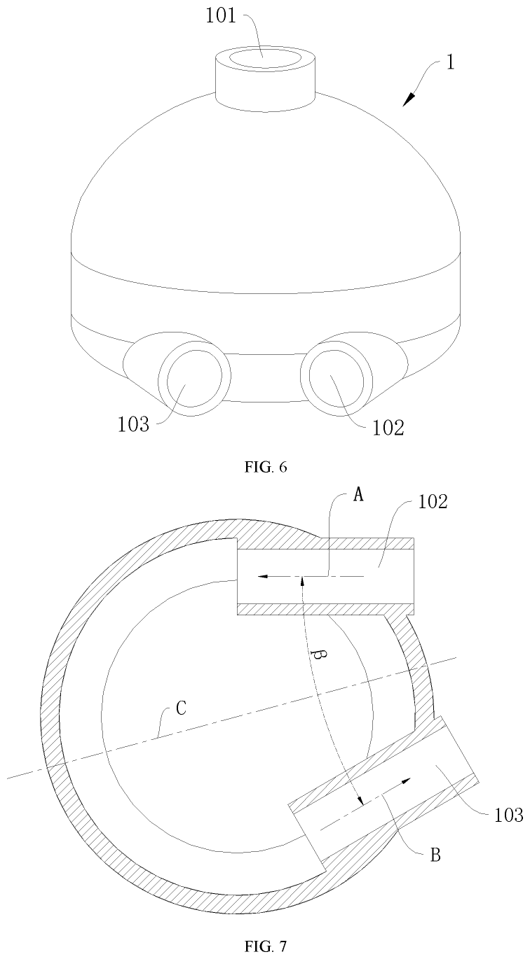

In one embodiment, as shown in FIG. 6 to FIG. 9, one of the liquid inlet 102 and the liquid outlet 103 extends away from the gas dissolution chamber 1 in a clockwise direction of the gas dissolution chamber 1, and the other of the liquid inlet 102 and the liquid outlet 103 extends away from the gas dissolution chamber 1 in a counterclockwise direction of the gas dissolution chamber 1. The liquid entering into the gas dissolution chamber 1 from the liquid inlet 102 will flow in a circumferential direction of the gas dissolution chamber 1 and flow toward the liquid outlet 103, and the flow of the liquid in the gas dissolution chamber 1 will also flow through a larger area, and the flow perturbation effect for the liquid in the gas dissolution chamber 1 will be generated, to improve the gas dissolving effect.

In addition, referring to FIG. 6 to FIG. 9, with the increase in the angle between the liquid discharging direction and the liquid feeding direction, the path from the liquid inlet 102 to the liquid outlet 103 increases, which effectively improves the flow perturbation effect for the liquid in the gas dissolution chamber 1, to improve the gas dissolving effect.

In one embodiment, the angle α between the liquid feeding direction A of the liquid inlet 102 and the liquid discharging direction B of the liquid outlet 103 is greater than 90°. For example, the angle between the liquid feeding direction A of the liquid inlet 102 and the liquid discharging direction B of the liquid outlet 103 is set to 150°. In one embodiment, the angle between the liquid feeding direction A of the liquid inlet 102 and the liquid discharging direction B of the liquid outlet 103 is in the range of 120° to 180°.

Of course, the angle between the liquid feeding direction and the liquid discharging direction can also be set to be less than 90°.

For example, the angle between the liquid feeding direction and the liquid discharging direction is set to 30°, 60°, 135°, 180°, or the like.

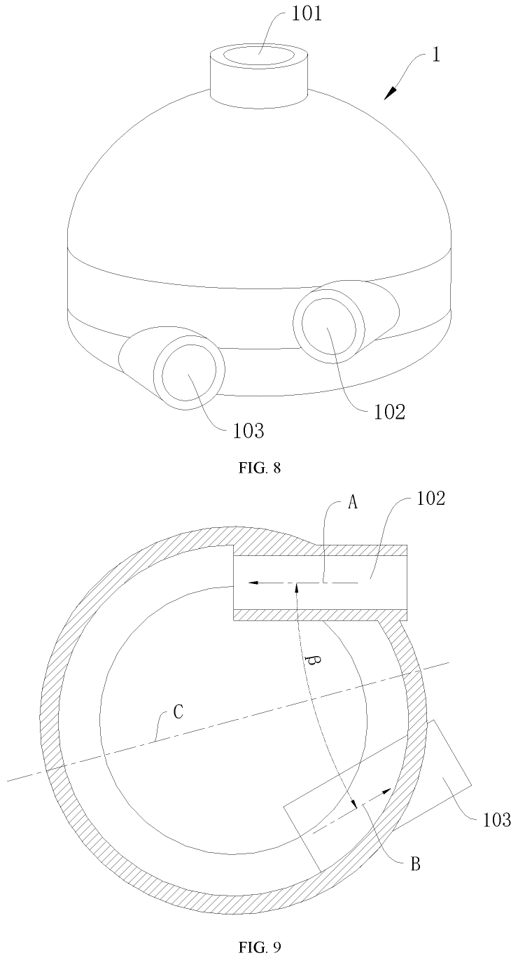

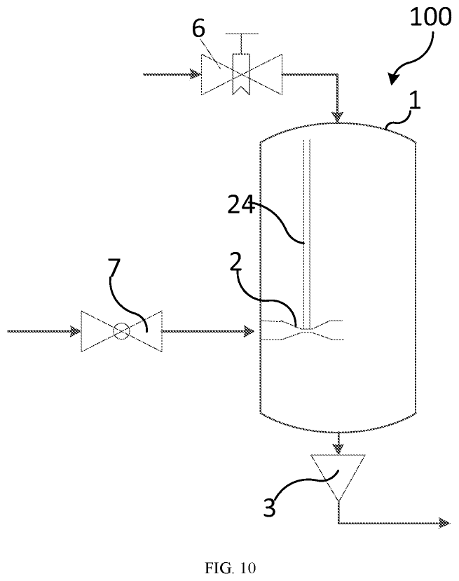

It should be noted that in FIG. 7 and FIG. 9, a marked angle β and the angle α are complementary to each other.

In one embodiment, the liquid inlet and the liquid outlet of the gas dissolution chamber can be extended in a tangential direction of the rotary housing. The liquid enters the rotary housing in a shell from the liquid inlet 102 along a tangent line, and the liquid will flow along an inner surface of the shell in a changed direction, to absorb a large amount of gas into the liquid and improving the dissolution rate of the gas in the liquid.

In one embodiment, the vent 101 is arranged at a top of the gas dissolution chamber 1, and the liquid inlet 102 and the liquid outlet 103 are arranged at a lower part of the gas dissolution chamber 1. The liquid entering the gas dissolution chamber 1 from the lower part can cause the gas in the gas dissolution chamber 1 to gather to the top, and with the rise of a liquid level in the gas dissolution chamber 1, the gas in the gas dissolution chamber 1 will also continuously enter into the bypass member 2 and be dissolved into the liquid to improve the gas dissolving effect, and the liquid inlet 102 and the liquid outlet 103 located at the lower part can also facilitate the discharging of the liquid in the gas dissolution chamber 1.

In one embodiment, the lower part of the gas dissolution chamber 1 is in a shape of a barrel. That is, the lower part of the gas dissolution chamber 1 is in a circular shape in a horizontal section thereof. Thus, it is convenient for the liquid in the gas dissolution chamber 1 to flow.

In one embodiment, an upper part of the gas dissolution chamber 1 is in a shape that gradually shrinks in a bottom-up direction. It is convenient for the gas stream to enter into the gas dissolution chamber 1 from the vent 101 or for the gas in the gas dissolution chamber 1 to be sent out from the vent 101, and due to the shape of the upper part of the gas dissolution chamber 1, when the gas dissolution chamber 1 is not installed properly, for example, the gas dissolution cavity 1 is tilted due to the problem of installation accuracy, the gas can still enter or exit the vent 101 smoothly.

In one embodiment, the liquid inlet 102 and the liquid outlet 103 are arranged on opposite sides of a plane passing through a centerline of the gas dissolution chamber 1. As shown in FIG. 5, there is a specific plane C on the gas dissolution chamber, which passes through the centerline of the gas dissolution chamber 1, and the liquid inlet 102 and the liquid outlet 103 are distributed on opposite sides of the plane C. In this way, the fluid entering into the gas dissolution chamber from the liquid inlet needs to flow out from the liquid outlet, and the flow path of the fluid in the gas dissolution chamber is relatively long, which improves the gas dissolving effect, and is easy to generate vortices and further improves the gas dissolving effect.

In one embodiment, the liquid inlet 102 and the liquid outlet 103 of the gas dissolution chamber in embodiments of the present disclosure can be arranged at different walls of the gas dissolution chamber. For example, one of the liquid inlet 102 and the liquid outlet 103 is connected to a bottom wall of the gas dissolution chamber, while the other of the liquid inlet 102 and the liquid outlet 103 is connected to a peripheral wall of the gas dissolution chamber.

In embodiments of the present disclosure, a venting valve 6 can be arranged to inflate the gas dissolution chamber 1 by opening or closing the venting valve 6. In one embodiment, in some embodiments of the present disclosure, the bubble generating device 100 further includes a venting valve 6, and one end of the venting valve 6 is communicated with the vent 101. Gas can enter into the gas dissolution chamber 1 through the venting valve 6 and the vent 101 when the venting valve 6 is opened, and the operation of the bubble generating device 100 will not be affected when the venting valve 6 is closed.

In one embodiment, the bubble generating device 100 further includes a gas pump 5, and two ends of the venting valve 6 are respectively connected to the vent 101 of the gas dissolution chamber 1 and the gas pump 5. Through the gas pump 5, gas can be actively filled into the gas dissolution chamber 1, and the discharging of liquid in the dissolved cavity 1 can be promoted under the action of the gas pressure filled by the gas pump 5.

In one embodiment, the bubble generating device 100 further includes a liquid feeding valve 4 communicated with the convergent section 21. In other words, the liquid feeding valve 4 is communicated with the inlet of the bypass member 2.

Of course, the bubble generating device 100 may not be provided with the liquid feeding valve 4, and whether to supply a liquid to the bubble generating device 100 is controlled by other structures (for example, a water source switch, etc.).

In addition, as shown in FIG. 8 and FIG. 9, the liquid inlet 102 and the liquid outlet 103 in embodiments of the present disclosure can be arranged to have a height difference. The liquid inlet 102 moves upward, and higher than the liquid outlet 103. Since the bubbles rise, this structure can further prevent the bubbles from entering the liquid outlet 103 and affecting the cavitation at the bubbler 3.

A washing apparatus according to an embodiment of the present disclosure includes the bubble generating device 100 according to the aforementioned embodiments.

In some embodiments of the present disclosure, the washing apparatus includes: an inner tank assembly, a bubble generating device 100 and a washing pump.

In one embodiment, an inlet of the washing pump is connected to the inner tank assembly, an outlet of the washing pump is connected to the inner tank assembly, and the connection between the washing pump and the inner tank assembly forms a circulatory washing loop, and the tableware or the like are washed through the washing loop.

In addition, the outlet of the washing pump is also connected with the inlet of the bubble generating device 100, and the outlet of the washing pump provides power to drive the liquid to enter into the bubble generating device 100, to generate microbubbles. The outlet of the bubble generating device 100 can be connected with the inlet of the washing pump, and more and smaller bubbles can be generated to participate in the washing process after multiple cycles, thus improving the effect of washing. The outlet of the bubble generating device 100 can also be connected with the inner tank assembly, and the bubbles generated by the bubble generating device 100 will be sent to the inner tank assembly to wash tableware or the like.

The outlet of the washing pump in embodiments of the present disclosure is respectively connected with the inlet of the bubble generating device 100 and the inner tank assembly, that is, the outlet of the washing pump will be divided into different pipelines to be connected with the bubble generating device 100 and the inner tank assembly respectively. The outlet of the washing pump connected with the inner tank assembly provides a liquid with kinetic energy to the inner tank assembly for washing, and the liquid connected with the bubble generating device 100 can generate bubbles and participate in the washing process, to improve the effect and efficiency of washing.

The washing apparatus according to the embodiment of the present disclosure utilizes the washing pump as the power to drive the liquid to enter into the bubble generating device 100 to generate microbubbles, and then the microbubbles participate in the washing process to improve the washing effect. In addition, since the bubble generating device 100 is not connected in series in the washing loop (formed by connecting the washing pump with the inner tank assembly), which reduces the influence on the circulatory washing process and further improves the effect of washing.

The washing apparatus in embodiments of the present disclosure utilizes the washing pump to provide energy, and the pressurized microbubbles generating device 100 can be effectively embedded in the washing apparatus to produce water containing high concentration micro-nano bubbles for washing. The bubbles has small diameter and can be preserved for a long time. In addition, the microbubbles are generated by the pump bypass circulation, and the influence on the mainstream flow pressure can be reduced by controlling the bypass flow rate, and water containing micro-nano bubbles can be generated by circulation in the washing process.

In other embodiments of the present disclosure, the bubble generating device 100 and the washing pump are respectively connected to the inner tank assembly, and the bubble generating device 100 and the washing pump are relatively independent.

The bubble generating device 100 according to the embodiment of the present disclosure reduces a height requirement of the gas dissolution chamber 1, and the gas dissolution chamber 1 can be adapted to a low installation space. The internal circulation mechanism of the gas in the gas dissolution chamber is established, and the gas dissolving efficiency and the bubble concentration are stable in the period of microbubble generation. The gas-liquid contact area is increased.

The bubble generating device 100 according to the embodiment of the present disclosure consists of a gas pump 5, a bypass member 2 (which can be a jet pump, a Venturi tube or a fluid element with similar functions), a gas dissolution chamber 1, a bubbler 3, a venting valve 6, and a liquid feeding valve 4. Connections similar to those shown in FIG. 1 to FIG. 9 should be within the scope of patent protection. It mainly lies in the connection mode between the bypass member 2 and the gas dissolution chamber 1. Under the same principle, the increase or decrease of some components or inlets and outlets should be within the scope of patent protection.

The principle of the bubble generating device 100 for generating a microbubble solution is as follows: in a stage of gas dissolving, the venting valve 6 is closed. The high-pressure liquid (for example, tap water) flows into the bypass member 2 through the liquid feeding valve 4, the bypass member 2 generates a high-speed and low-pressure flow at the throat section 22, the gas in an upper part of the gas dissolution chamber 1 is sucked into the bypass member 2, and the gas phase and the liquid phase are mixed for the first time in a jet pump/Venturi tube.

Then, the mixed fluid enters the gas dissolution chamber 1. Due to the throttling effect of the bubbler 3, a liquid feeding velocity of the gas dissolution chamber 1 is greater than a liquid discharging velocity, and the pressure of the gas dissolution chamber 1 continues to rise until the pressure is approximately equal to the total pressure of the high-pressure liquid. As the pressure rises, the gas in the gas dissolution chamber 1 continues to dissolve in the liquid (the higher the pressure, the higher the dissolution rate of the gas is). During this process, the gas in the upper part of the gas dissolution chamber 1 is also pressurized, and the amount of gas entering the bypass member 2 is further increased until the dynamic equilibrium, the internal circulation mechanism of the gas in the gas dissolution chamber 1 is established. The gas in the upper part of the gas dissolution chamber 1 is sucked into the bypass member 2, and then returns to the gas dissolution chamber 1, and accumulates at the upper part of the gas dissolution chamber 1 to complete the internal circulation.

When the gas solution flows to the bubbler 3, in the throttling process, the overflow cross-sectional area continues to decrease, the flow rate increases, the pressure decreases, and the gas continues to evolve by cavitation, to generate a large number of microbubbles and forming a microbubble solution.

When the liquid is discharged, the liquid feeding valve 4 is closed, the venting valve 6 is opened, and the gas pump 5 is opened, and the liquid is discharged through gas pressurization. In another embodiment, discharging of the liquid by gravity can be carried out through the liquid level difference without the use of the gas pump 5, and at this time, the rear pipeline of the bubbler 3 should be lowered as much as possible to ensure a large liquid level difference.

FIG. 6 and FIG. 7 are schematic views of the gas dissolution chamber 1, a lower part of the gas dissolution chamber 1 is in a cylindrical shape and an upper part of the gas dissolution chamber 1 is in a shape of a hemispherical shell or cone, with other similar shapes being within the scope of patent protection (with emphasis on the structure of the gas dissolution chamber 1 based on the cyclone separation principle). It consists of a liquid inlet 102, a liquid outlet 103 and a vent 101. In this embodiment, an angle between the liquid inlet and the liquid outlet 103 is 150 degrees, but the other angle changes are within the scope of patent protection.

The mixed fluid generated by the bypass member 2 enters the gas dissolution chamber 1 through the liquid inlet 102, and the liquid will rotate in the gas dissolution chamber 1 since the gas dissolution chamber 1 is in a cylindrical shape. The rotation has two functions: on one hand, it generates rotational shear stress to accelerate the dissolution of the gas into the liquid; on the other hand, it produces a cyclone separation effect, in which large bubbles as a discrete phase gather to the center of rotation, float up, and return to the bypass member 2 via the vent 101 for a next cycle. The liquid outlet 103 is arranged at the cylindrical outer ring, and there will no large bubbles entering the liquid outlet 103 to affect the cavitation due to the existence of cyclone separation.

Embodiments of the present disclosure reduces the height requirement of the gas dissolution chamber 1. By utilizing the high pressure of the gas in the upper part of the gas dissolution chamber 1 and a low pressure at the throat section 22 of the bypass member 2, the gas enters into the gas dissolution chamber 1 from any direction. The internal circulation mechanism of the gas in the gas dissolution chamber 1 is established, and the gas dissolving efficiency and the bubble concentration are stable. The height of the liquid level in the gas dissolution chamber 1 no longer affects the bubble concentration. The gas-liquid contact area is increased by premixing the gas and the liquid through the bypass member 2. The rotational shear stress of the cylindrical gas dissolution chamber 1 increases the gas dissolving efficiency. The cyclone separation prevents large bubbles from entering the liquid outlet 103 and affecting the cavitation at the bubbler 3.

FIG. 4 and FIG. 5 are schematic views of the gas dissolution chamber 1, whose structure is similar to that of the first gas dissolution chamber 1, but an angle of the liquid outlet 103 is changed. At this time, the S flow of the gas-liquid mixed fluid is carried out in the gas dissolution chamber 1, which prevents the bubbles from being carried into the liquid outlet 103 when the flow rate of a feeding liquid or a discharging liquid is large. Moreover, this structure can further prevent the bubbles from entering the liquid outlet 103 and affecting the cavitation at the bubbler 3.

The bubble generating device 100 according to the embodiment of the present disclosure provides a connection mode between the bypass member 2 and the gas dissolution chamber 1. Under the same principle, the increase or decrease of some components or inlets and outlets should be within the scope of patent protection. The gas dissolution chamber 1 is a structure of gas dissolution chamber 1 based on the principle of cyclone separation. Taking the flow direction as a reference direction, in the gas dissolution chamber 1, an angle between a flow direction of the liquid inlet 102 and a flow direction of the liquid outlet 103 is greater than 90 degrees, that is, the rotation angle of the liquid flow in the gas dissolution chamber 1 should be greater than 90 degrees.

As shown in FIG. 10, in some embodiments of the present disclosure, the bypass member 2 is arranged in the gas dissolution chamber 1 provided with a gas storage space, a bypass inlet 201 can be communicated with the liquid inlet 102, a bypass outlet 202 is communicated with an inner space of the gas dissolution chamber 1, and a throat section 22 is communicated with the gas storage space in the gas dissolution chamber 1. Therefore, a liquid can flow into the gas dissolution chamber 1 through the bypass member 2, and in the process of the liquid flowing into the gas dissolution cavity 105 through the bypass member 2, when the liquid passes through the throat section 22, a high-speed and low-pressure area will be formed. At this time, the gas in the gas storage space will enter into the throat section 22 and mix with the high-speed and low-pressure liquid at the throat section 22, to improve the premixing of the gas and the liquid entering the gas dissolution cavity 105. Further, the vent 101 can be configured in a form of a unidirectional intake. In this way, as the liquid level rises with the liquid feeding, the gas pressure in the gas dissolution cavity 105 increases, and the gas can enter the throat section 22 more easily and premix with the liquid to improve the effect of gas-liquid premixing.

The gas storage space in embodiments of the present disclosure can be arranged at the top of the gas dissolution chamber. Since the gas is more easily compressed relative to the liquid, the gas pressure in the gas storage space gradually increases with the rise of the liquid level in the gas dissolution chamber and the gas-liquid premixing in the bypass member 2 is easier to achieve.

In one embodiment, the gas storage space in embodiments of the present disclosure can also be arranged at other positions in the gas dissolution chamber, for example, the gas storage space is arranged in a lateral part of the gas dissolution chamber, as long as a high pressure can be formed in the gas storage space and the gas can enter the bypass member for premixing. In order to maintain the gas pressure in the gas storage space, the gas storage space can be actively inflated, to produce a higher gas pressure in the gas storage space. In addition, if the gas storage space is not located at the top of the gas dissolution chamber, the gas pressure in the gas storage space can also be increased when the liquid level rises within a predetermined range.

In addition, in other embodiments of the present disclosure, the throat section 22 may also be communicated with the vent 101, and the bypass outlet 202 may be communicated with the liquid inlet 102. In this way, the liquid can flow into the gas dissolution chamber 1 through the bypass member 2, and a part of the gas in the liquid flowing into the gas dissolution chamber 1 from the bypass member 2 will be released into the gas dissolution chamber 1, while the gas in the gas dissolution chamber 1 (including the gas originally existing in the gas dissolution chamber 1 and a part of the gas released from the liquid flowing in to the gas dissolution chamber 1 from the bypass member 2) can also flow into the throat section 22 through the vent 101. In one embodiment, during the liquid feeding process, the liquid can flow at high speed and low pressure in the throat section 22, the gas in the gas dissolution chamber 1 enters into the bypass member 2 through the vent 101 to form a gas-liquid mixed fluid, and then enters into the gas dissolution chamber 1, and the liquid is subjected to further gas-liquid mixing in the gas dissolution chamber 1. In the gas dissolution chamber 1, a part of the gas in the liquid follows the liquid into the bubbler 3 to generate bubbles, while another part of the gas in the liquid may evolve into the upper part of the gas dissolution chamber 1 and can flow to the bypass member 2 again. Of course, the gas entering the bypass member 2 from the vent 101 can also be completely dissolved in the liquid and all follow the liquid into the bubbler 3 to generate bubbles.

In one embodiment, an inner diameter of the throat section 22 is in the range of 2 millimeters to 4 millimeters. For example, the inner diameter of the throat section 22 is set to be 2 mm, 2.4 mm, 3.8 mm. In one embodiment, the inner diameter of the throat section 22 is selected to be 2.4 mm. Therefore, on one hand, the low-pressure suction effect is caused by accelerating the flow, and on the other hand, it is possible to avoid the reduction of the cavitation effect of the bubbler 3 due to excessive pressure loss.

Of course, the inner diameter of the throat section 22 can also be set to less than 2 mm and greater than 4 mm, which is not limited in embodiments of the present disclosure.

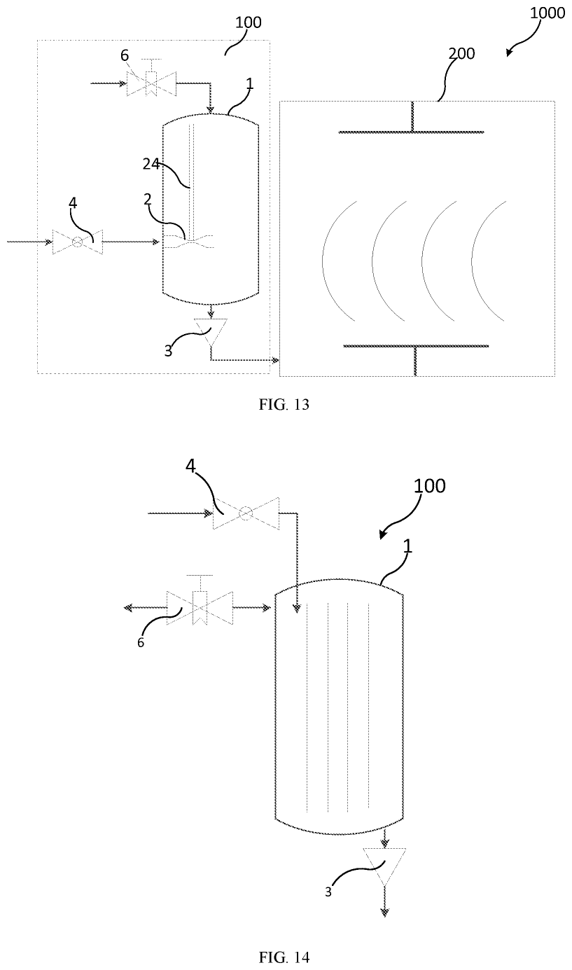

In one embodiment, referring to FIG. 10 to FIG. 13, the bypass member 2 is arranged in the gas dissolution chamber 1, and thus a structural size of the gas dissolution chamber 1 can be effectively reduced by arranging the bypass member 2 in the gas dissolution chamber 1.

In one embodiment, referring to FIG. 10 to FIG. 13, the bypass member 2 is arranged in a lower part of the gas dissolution chamber 1, and a connecting pipe 24 is connected with the throat section of the bypass member 2, and communicated with the throat section 22 and extends upward to an upper part of the gas dissolution chamber 1. An upper end of the connecting pipe 24 extends upward to approach or access the gas storage space. At this time, after the premixed fluid is entered into the gas dissolution cavity 105, the fluid will be gradually stabilized, and the gas originally premixed in the liquid may evolve, but when the bypass member 2 is arranged in the lower part of the gas dissolution chamber 1, the evolved gas will have more contact with the liquid in the rising process, to effectively improve the effect of gas-liquid mixing and improve the gas dissolving rate of the liquid in the gas dissolution cavity 105.

In one embodiment, the bypass member 2 and the gas dissolution chamber 1 can be configured into an integral structure, that is, the bypass member 2 is integrated on the gas dissolution chamber 1. For example, the gas dissolution chamber 1 is divided into a first shell 11 and a second shell 12 fastened to each other to form the gas dissolution cavity 105, a first bypass structure is integrally integrated on the first shell 11, and a second bypass structure is integrally integrated on the second shell 12. After the first shell 11 is fastened to the second shell 12, the first bypass structure and the second bypass structure are combined to form the bypass member 2.

The bypass member 2 in embodiments of the present disclosure may be a Venturi tube.

It can be seen from the preceding description that the gas dissolving rate can be effectively improved by increasing the gas pressure in the gas dissolution cavity 105, and the gas-liquid mixing efficiency in the bypass member 2 can be effectively improved by increasing the gas pressure in the gas dissolution cavity 105. The gas dissolution cavity 105 can be actively inflated to increase the gas pressure in the gas dissolution cavity 105. The vent 101 can also be configured in the form of unidirectional intake, and the gas pressure in the dissolving chamber 105 will increase as the liquid enters the gas dissolution chamber 1 through the liquid inlet 102.

In one embodiment, referring to FIG. 10 to FIG. 14, the bubble generating device 100 further includes a venting valve 6 connected to the vent 101, and configured to allow unidirectional flow of a gas stream toward an inner space of the gas dissolution chamber 1. That is, the gas in the external environment can enter into the gas dissolution cavity 105 through the venting valve 6, but the gas in the gas dissolution cavity 105 is difficult to discharge. With the liquid feeding at the liquid inlet 102, the gas pressure in the gas dissolution cavity 105 will gradually rise, thus effectively improving the gas dissolving rate of the liquid in a container compartment.

In one embodiment, when the liquid enters the bypass member 2, it is injected into the gas dissolution cavity 105 through the bypass outlet 202. The bubbler 3 installed at a rear end of the liquid outlet 103 of the gas dissolution cavity 105 has a throttling effect, and the venting valve 6 also prevents the gas discharging in the gas dissolution cavity 105, so the gas pressure in the gas dissolution cavity 105 increases as the liquid level rises, and the gas in the upper part of the gas dissolution chamber 1 is compressed. In addition, since the throat section 22 of the bypass member 2 is communicated with a gas storage space in the gas dissolution cavity 105, the flow velocity of the liquid increases and the pressure of the liquid decreases when the liquid passes through the throat section 22. Under the combined action of the decrease in the pressure of the liquid and the increase in the pressure of the gas, the gas pressure in the upper part of the gas dissolution cavity 105 will be greater than the liquid pressure at the throat section 22, and the gas enters the throat section 22 to form a premix, and then is ejected into the gas dissolution chamber 1 through the bypass outlet 202, that is, the premixed fluid is injected into the gas dissolution cavity 105 from the bypass outlet 202 of the bypass member 2.

The venting valve 6 is configured to allow unidirectional flow of a gas stream toward the inner space of the gas dissolution chamber 1. As an example, the venting valve 6 is configured as a unidirectional valve. As another example, the venting valve 6 is configured as a controllable valve. When the gas stream flows from the outside to the gas dissolution cavity 105 (an external gas pressure of the gas dissolution cavity 105 is greater than an internal gas pressure of the gas dissolution cavity 105), the venting valve 6 is opened; when the gas stream may flow from the dissolved chamber 105 to the outside (the external gas pressure of the gas dissolution cavity 105 is less than the internal gas pressure of the gas dissolution cavity 105), the venting valve 6 is closed. In addition, the venting valve 6 can also be opened or closed for other purposes.

After the gas-liquid mixed fluid enters the gas dissolution chamber through the liquid inlet, the gas in the gas-liquid mixed fluid rises continuously and enters the gas storage space in the gas dissolution cavity 105 to form a gas circulation. Due to the existence of circulating bubbles, the gas-liquid contact area is increased, and the gas dissolving efficiency is improved.

Of course, as mentioned above, it is also possible to add the gas pressure pump to inflate the gas dissolution cavity 105 to form a high pressure.

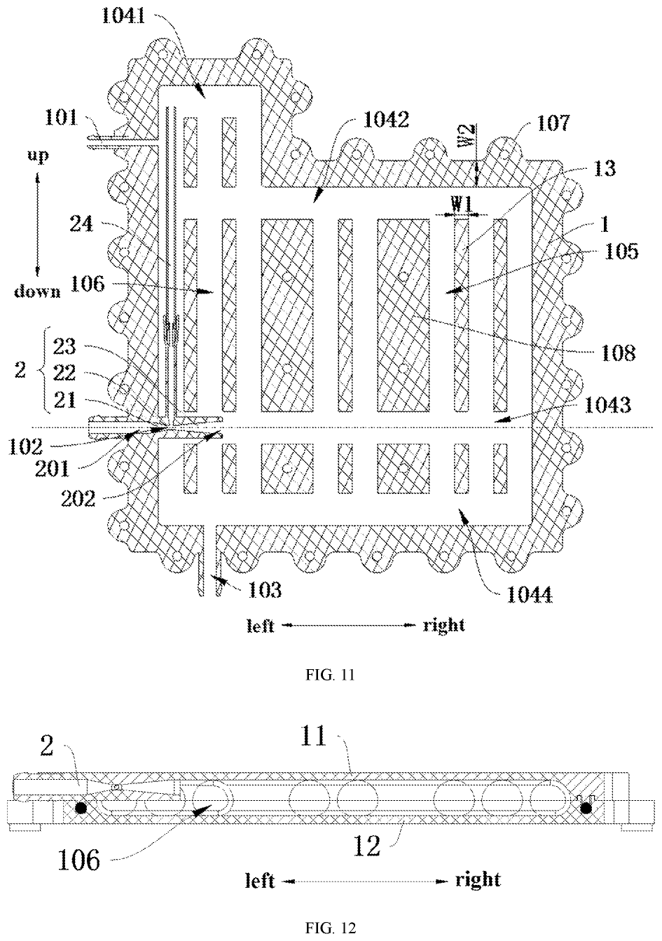

In addition, as mentioned above, in order to effectively increase the gas dissolving rate of the liquid in the gas dissolution cavity 105, a relatively high gas pressure is needed in the gas dissolution cavity 105. The high pressure inside the gas dissolution cavity 105 will affect the structural strength and stability of the gas dissolution chamber 1. Therefore, as shown in FIG. 11, in embodiments of the present disclosure, a reinforcing rib 13 is arranged in the gas dissolution chamber 1. The reinforcing rib 13 can improve the structural strength of the gas dissolution chamber 1.

Since the liquid inlet 102 and the vent 101 will introduce a fluid into the gas dissolution cavity 105, and the fluid is sent out from the liquid outlet 103, a channel for fluid flowing needs to be arranged in the gas dissolution chamber 1.

In one embodiment, as shown in FIG. 11, the reinforcing rib 13 divides the gas dissolution chamber 1 into transverse channels. The transverse channels extend in a horizontal direction, and transverse channels are sequentially arranged in an up-down direction and communicated with each other. The gas dissolving rate can be improved.

In one embodiment, transverse channels include a first transverse channel 1041, a second transverse channel 1042, a third transverse channel 1043, and a fourth transverse channel 1044 in a top-down direction.

The first transverse channel 1041 can be arranged in the gas storage space, where the gas in the gas dissolution cavity 105 will accumulate. In conjunction with the foregoing description, with the rise of the liquid level, the gas pressure in the upper part of the gas dissolution cavity 105 will increase, and the connecting pipe 24 communicated with the throat section 22 will lead to the gas storage space. At this time, the gas pressure in the gas storage space will cause the gas to enter into the throat section 22 through the connecting pipe 24, thus completing a gas-liquid premixing.

In one embodiment, the liquid outlet 103 is communicated with the fourth transverse channel 1044, to facilitate the discharging of the liquid in the gas dissolution cavity 105.

In one embodiment, the liquid is supplied from the liquid inlet 102 to the third transverse channel 1043. In this way, with respect to the liquid outlet 103, the liquid inlet 102 is communicated with a different transverse channel, to prevent the gas-liquid mixed fluid entering the gas dissolution chamber via the liquid inlet 102 from entering the bubbler directly and affecting the generation of bubbles, thus improving the efficiency of bubble generation.

Further, in conjunction with the foregoing embodiments, the bypass outlet is opposite to the third channel 1043. Further, a liquid discharging direction of the bypass outlet is parallel to an extension direction of the third transverse channel, and after the gas-liquid mixed fluid enters the gas dissolution chamber, it can be expanded in the third channel 1043. Moreover, when part of the gas is evolved from the liquid, the gas can come into contact with more liquid and it is possible to avoid affecting the efficiency of bubble generation of the bubbler.

In one embodiment, the first transverse channel 1041, the second transverse channel 1042, the third transverse channel 1043 and the fourth transverse channel 1044 are arranged at intervals in the up-down direction. The first transverse channel 1041 is configured to communicate with the gas storage space and maximize a gas utilization. The second transverse channel 1042 is configured to allow the gas to flow toward the gas storage space. The third transverse channel 1043 is configured to provide a jet path for the premixed gas, where part of the gas mixed in the liquid will be expanded in the horizontal direction after the gas-liquid mixed fluid ejected from the bypass outlet 202 of the bypass member 2 enters the third transverse channel 1043, to maximize the gas-liquid contact area. In addition, the third transverse channel 1043 in embodiments of the present disclosure is higher than the fourth transverse channel 1044, which can prevent the premixed gas in the bypass member 2 from entering the liquid outlet 103 directly (the gas is compressible and the gas entering the bubbler 3 will inhibit cavitation).

On the other hand, the third transverse channel 1043 is farther away from the second transverse channel 1042, or in other words, a distance between the second transverse channel 1042 and the third transverse channel 1043 is greater than that between the first transverse channel 1041 and the second transverse channel 1042, and greater than that between the third transverse channel 1043 and the fourth transverse channel 1044, which can maximize the ascending path of the premixed gas and increase the gas-liquid contact time. The fourth transverse channel 1044 is configured to communicate with a bottom space of the gas dissolution chamber 1, and all the liquid in the gas dissolution chamber 1 can be drained in the process of drainage and gas intake.

In addition, the liquid outlet is arranged at a bottom wall of the fourth transverse channel, and the liquid in the gas dissolution chamber can be discharged conveniently.

In one embodiment, the gas dissolution chamber 1 is divided into longitudinal channels 106 by the reinforcing rib 13. Longitudinal channels 106 are arranged at intervals in the horizontal direction, the longitudinal channels 106 extend in the up-down direction and intersect the transverse channels in the up-down direction, and the longitudinal channels 106 and the transverse channels are interlaced and communicated with each other.

Referring to FIG. 12, the longitudinal channels 106 in embodiments of the present disclosure are in a shape of a circular hole.

In one embodiment, a width W1 of the reinforcing rib 13 is in the range of 2 millimeters to 5 millimeters. For example, the width W1 of the reinforcing rib 13 is set to 2 millimeters, 3 millimeters, or 4.1 millimeters, to improve the structural strength of the gas dissolution chamber 1. Of course, the width W1 of the reinforcing rib 13 can also be set to less than 2 millimeters or greater than 5 millimeters.

In one embodiment, a horizontal cross-sectional area of the gas storage space is less than a horizontal cross-sectional area of a space below the gas storage space. This facilitates the accumulation of the gas stream and causes the gas stream to enter into the throat section 22 under the action of gas pressure to complete the gas-liquid premixing, to improve the efficiency of gas-liquid mixing.

Referring to the drawings, the horizontal cross-sectional refers to a section perpendicular to the up-down direction.

In one embodiment, the gas dissolution chamber 1 is in a flat shape. Therefore, the bubble generating device 100 can be provided on a side wall, a door, a top wall or other positions of the washing apparatus 1000, which can effectively reduce a space occupied by the bubble generating device 100 and thus improve a space occupancy rate.

In addition, a wall thickness W2 of the gas dissolution chamber 1 in embodiments of the present disclosure may be in the range of 2 millimeters to 5 millimeters. For example, the wall thickness W2 of the gas dissolution chamber is set to 2 millimeters, 3 millimeters, or 4.1 millimeters, which can effectively improve the stability and safety of the gas dissolution chamber 1, and meet the requirements of pressure bearing and welding at the same time.

Of course, the wall thickness W2 can also be set to less than 2 millimeters or greater than 5 millimeters.

In one embodiment, referring to FIG. 10 to FIG. 13, the gas dissolution chamber 1 includes a first shell 11 and a second shell 12 fastened to each other to form a gas dissolution cavity 105, and a middle and a periphery of the first shell 11 are fixedly connected with a middle and a periphery of the second shell 12, respectively. Therefore, the structure of the gas dissolution chamber 1 can be simplified, and the gas dissolving effect of the gas dissolution chamber 1 can be improved.

In one embodiment, bumps 107 are provided at the periphery of the first shell 11 and the periphery of the second shell 12, and the bumps 107 on the first shell 11 are correspondingly connected with the bumps 107 on the second shell 12 to connect the periphery of the first shell 11 with the periphery of the second shell 12. Therefore, the fitting of the first shell 11 and the second shell 12 can be effectively facilitated, and the structural strength of the gas dissolution chamber 1 can be improved, to avoid the influence of the wall thickness of the gas dissolution chamber 1 due to the arrangement of a fixing member, and thus improve the structure strength and stability of the gas dissolution chamber 1.

The first shell and the second shell can be connected by bolting, screwing or riveting, and mounting holes need to be arranged on the first shell and the second shell. The mounting holes on the first shell can be arranged on or adjacent to the bumps on the first shell, and the mounting holes on the second shell can be arranged on or adjacent to the bumps on the second shell. In this way, the structural strength of or connection strength between the first shell and the second shell can be effectively ensured.

Of course, the first shell 11 and the second shell 12 can also be connected by welding or the like, and the arrangement of the bumps can also improve the connection strength between the first shell 11 and the second shell 12.

In one embodiment, a fixing block 108 is arranged in a middle of the gas dissolution chamber, or in other words arranged in a middle of the gas dissolution cavity 105, and used for fixing piece connection to connect the middle of the first shell 11 with the middle of the second shell 12. By arranging the fixing block 108, the middle of the first shell 11 and the middle of the second shell 12 can be connected together, to improve the stability and structural strength of the gas dissolution chamber 1.

In addition, the aforementioned bypass member 2 can be formed on the first shell 11, and the gas dissolution cavity 105 can be formed by the cooperation of the first shell 11 and the second shell 12. In one embodiment, the periphery of the first shell 11 is provided with a convex ring, the periphery of the second shell 12 is provided with a concave ring, the convex ring can be embedded in the concave ring, a sealing ring can be arranged in the concave ring, and the convex ring is embedded in the concave ring and pressed on the sealing ring to form a sealing structure.

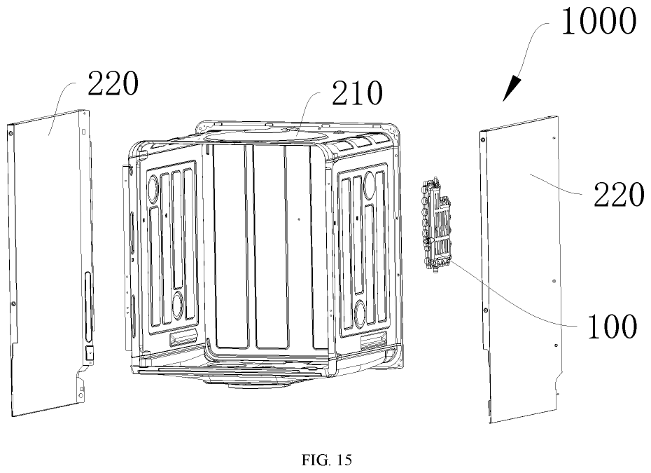

In addition, embodiments of the present disclosure also provides other solutions for improving the gas dissolving rate. As shown in FIG. 14, the liquid inlet 102 is arranged in the upper part of the gas dissolution chamber 1 and configured to feed the liquid downward, and the liquid outlet 103 is arranged in the lower part of the gas dissolution chamber 1 and away from a position pointed to by a liquid feeding direction of the liquid inlet 102. When the liquid enters the gas dissolution chamber 1 via the liquid inlet 102, it leads to a liquid level in the gas dissolution chamber 1, to carry more gas into the liquid in the gas dissolution cavity 105, which can improve the container efficiency and the bubble generation efficiency.

The position in the lower part of the gas dissolution chamber 1 pointed to by the liquid feeding direction of the liquid inlet 102 refers to a position in the lower part of the gas dissolution chamber 1 facing the liquid inlet 102 in the liquid feeding direction of the liquid inlet 102. For example, when the gas is fed downward from the liquid inlet 102, the position in the lower part of the gas dissolution chamber 1 pointed to by the liquid feeding direction of the liquid inlet 102 is a position in the lower part of the gas dissolution chamber 1 which is directly opposite to the liquid inlet 102 in the up-down direction.

In addition, the vent 101 can be arranged at the upper part of the gas dissolution chamber 1, and a gas intake direction of the vent 101 can be configured to be allow a joint of the feeding gas and the feeding liquid.

The difference between this solution and the aforementioned solution of adding the bypass member 2 lies in that fact that the liquid inlet 102 and the vent 101 are arranged at the upper part of the gas dissolution chamber 1, and the liquid entered through the liquid inlet 102 joins with the gas entered through the vent 101, and the liquid carries the gas for flowing. In one embodiment, the liquid inlet 102 of the gas dissolution chamber 1 is located at the upper part of the gas dissolution chamber 1 and configured to feed the liquid downward, and water is flushed into the liquid surface at a high speed, carrying the gas into the liquid surface, generating bubbles, increasing the gas-liquid contact area, and thus increasing the gas dissolving efficiency. At the same time, the liquid outlet 103 is arranged at a position away from an area directly below the liquid inlet 102 to prevent the gas from directly entering the bubbler 3 and inhibiting the generation of microbubbles.

In conjunction with the foregoing embodiment, the liquid outlet 103 is arranged at the lower part of the gas dissolution chamber 1, Further, the vent 101 and the liquid inlet 102 are arranged at one side of the upper part of the gas dissolution chamber 1 in a horizontal direction, and the liquid outlet 103 is arranged at the other side of the lower part of the gas dissolution chamber 1 in the horizontal direction. Further, reinforcing ribs 13 can be arranged at intervals in the horizontal direction and extend in the up-down direction.

It should be noted that the up-down direction mentioned in embodiments of the present disclosure refers to an up-down direction in the drawings, and the horizontal direction in embodiments of the present disclosure refers to a left-right direction in the drawings. Of course, the specific description of the direction here is only a description according to the orientation shown in the drawings, but is not intended to limit the protection scope of the present disclosure. Based on the different placement ways of the bubble generating device, the up-down direction and the horizontal direction in embodiments of the present disclosure will change accordingly.

In conjunction with the foregoing embodiments, the gas dissolution chamber 1 in embodiments of the present disclosure is filled with gas in the stage of gas dissolving. The liquid feeding valve 4 is opened. Due to the throttling effect of the bubbler 3, the liquid feeding velocity of the gas dissolution chamber 1 is greater than the liquid discharging velocity, and thus the pressure in the gas dissolution chamber 1 increases continuously (a dynamic pressure of liquid flowing during this process is continuously converted into a static pressure of the medium in the gas dissolution chamber 1). Since the pressure in the gas dissolution chamber 1 increases and the venting valve 6 is closed, the gas cannot be released from the venting valve 6 (a unidirectional flow direction from the outside to the gas dissolution chamber 1). Due to the increase in the pressure, the gas in the gas dissolution chamber 1 continues to dissolve in the liquid (the higher the pressure, the higher the gas dissolution rate is). When the gas-liquid mixed fluid flows to the bubbler 3, during the throttling process, the cross-sectional area of the overflow continues to shrink, the flow rate increases, the pressure decreases, and the gas is continuously evolved by cavitation, to generate a large number of microbubbles. The liquid containing microbubbles re-passes through the pump and then enters the washing system.

In order to improve the gas dissolving efficiency, it is necessary to increase the gas-liquid contact area. The bypass member 2 is installed at a liquid feeding position of the gas dissolution chamber 1. An overflow cross-sectional area of a neck (throat section 22) of the bypass member 2 is continuously reduced, the flow rate increases, the pressure decreases, and the high-pressure gas at a top of the gas dissolution chamber 1 is pumped into the bypass member 2 to realize the premixing of the gas and the liquid and thus increase the gas-liquid contact area.

As the gas in the gas dissolution chamber 1 is continuously dissolved in the liquid, the gas in the gas dissolution chamber 1 is continuously reduced. Therefore, after a period of time, it is necessary to discharge the fluid. When the liquid is discharged, the liquid feeding valve 4 is closed. As the liquid in the gas dissolution cavity 105 continuously flows out with the bubbler 3, the pressure in the gas dissolution chamber 1 decreases, and the venting valve 6 is automatically opened at this time. The venting valve 6 is located at the upper part of the gas dissolution chamber 1, and the liquid in the gas dissolution chamber 1 will flow back to the inner tank through the bubbler 3 under the action of gravity. The gas enters through the venting valve 6 and refills the gas dissolution chamber 1.

A gas medium is not only air, but can also be other gas mediums, such as a gaseous freshener or the like. A liquid medium is not only water, but may also be a cleaning agent or the like.

The gas dissolution chamber 1 has a liquid inlet 102, a vent 101 and a liquid outlet 103. The vent 101 is arranged at a top of the gas dissolution chamber 1. In the drainage process, when the venting valve 6 is opened in the drawings, the liquid in the gas dissolution chamber 1 flows out. The liquid outlet 103 is arranged at a bottom of the gas dissolution chamber 1, which is beneficial to drainage of all the water in the gas dissolution chamber 1 by gravity, and the gas dissolution chamber 1 is refilled with air. The liquid inlet 102 is arranged in a middle-lower part of the gas dissolution chamber 1 (i.e., a third transverse channel 1043). On the one hand, since the gas will rise, this position can prevent the premixed gas in the bypass member 2 from entering the liquid outlet 103 directly (the gas is compressible, and the gas entering the bubbler 3 will inhibit cavitation). On the other hand, this position can maximize the ascending path of the premixed gas and increase the gas-liquid contact time. The gas dissolution chamber 1 is of an L-shape, with an upper-left part having a gas storage space, where the vent 101 of the bypass member 2 is located in this cavity. In the process of dissolving gas, the pressure in the chamber is high, and the gas will be compressed and accumulated in the upper part of the gas dissolution chamber 1. Arrangement of the gas storage space with a smaller horizontal cross-sectional area can maximize the utilization rate of the gas.

The gas dissolution chamber 1 has transverse channels. A first transverse channel 1041 is configured to communicate with the gas storage space and maximize the gas utilization rate. A second transverse channel 1042 is configured to allow the gas to flow toward the gas storage space. A third transverse channel 1043 is configured to provide a jet path for the premixed gas, and the bubbles ejected from a premixing outlet of the bypass member 2 will expand in the horizontal direction and thus maximize the gas-liquid contact area. Since the gas will rise, the third transverse channel 1043 is higher than the fourth transverse channel 1044, which can prevent the premixed gas in the bypass member 2 from entering the liquid outlet 103 directly (the gas is compressible, and the gas entering the bubbler 3 will inhibit cavitation). On the other hand, the third transverse channel 1043 is farther away from the second transverse channel 1042 (for example, a distance between the third transverse channel 1043 and the second transverse channel 1042 is greater than other distances between transverse channels), which can maximize the ascending path of the premixed gas and increase the gas-liquid contact time. A fourth transverse channel 1044 is configured to communicate with a bottom space of the gas dissolution chamber 1, and all the liquid in the gas dissolution chamber 1 can be drained in the process of drainage and gas intake.

The gas dissolution chamber 1 is a pressure-bearing container. In this embodiment, the material is plastic (it can also be made of other materials). Thus, in order to increase the structural strength, a pipe arrangement is adopted, such as a vertical channel, with its cross section being quasi-circular to optimize the pressure-bearing capacity. The reinforcement structure (multiple vertical reinforcing ribs in parallel and at intervals) of the gas dissolution chamber 1 can be welded to prevent high-pressure bursting. In addition, a reinforcing screw hole is arranged in the middle of the gas dissolution chamber 1, which is connected by bolts to prevent the middle deformation of the gas dissolution chamber 1 caused by the pressure. In this embodiment, a thickness of the reinforcing rib 13 and a thickness of a wall are set to 3 mm to meet the requirement of pressure bearing and welding. The bypass member 2 can be integrally formed into the gas dissolution chamber 1 (integral injection molding). During the processing, the gas dissolution chamber 1 is divided into an upper piece and a lower piece, which can be sealed by welding or through a sealing ring and a screw. In this embodiment, a position of the sealing ring is shown at the sealing ring.

In this embodiment, the throat section 22 of the bypass member 2 is set to 2.4 mm, on the one hand, to accelerate the flowing to cause a low-pressure suction effect, and on the other hand, to prevent the cavitation effect of the bubbler 3 from being reduced due to excessive pressure loss. In order to simplify the design of the mold, a vertical section of the bypass member 2 is configured as a two-section connection, which is connected by a sealing ring.

In conjunction with FIG. 10, in one embodiment of the present disclosure, the bubble generating device 100 includes a gas dissolution chamber 1, a bypass member 2, a bubbler 3, a venting valve 6, and a liquid feeding valve 4. A liquid inlet 102, a vent 101 and a liquid outlet 103 are arranged at the gas dissolution chamber 1, and a top of the gas dissolution chamber 1 has a gas storage space. The liquid feeding valve 4 is communicated with the liquid inlet 102, the venting valve 6 is communicated with the vent 101, and the bubbler 3 is communicated with the liquid outlet 103. The bypass member 2 is arranged in the gas dissolution chamber 1. The bypass member 2 includes a convergent section 21, a throat section 22 and a divergent section 23. The convergent section 21 is communicated with the liquid inlet 102, the throat section 22 is communicated with the gas storage space, and the convergent section 23 is configured to supply a liquid into the gas dissolution chamber 1.

In conjunction with FIG. 11, reinforcing ribs 13 are arranged in the gas dissolution chamber, and divide the gas dissolution chamber 1 into transverse channels and longitudinal channels. The transverse channels extend in a horizontal direction, and transverse channels are sequentially arranged in an up-down direction. Transverse channels include a first transverse channel 1041, a second transverse channel 1042, a third transverse channel 1043, and a fourth transverse channel 1044 in a top-down direction. Longitudinal channels 106 extend in the up-down direction, longitudinal channels 106 are arranged at intervals in the horizontal direction and intersect the transverse channels in the up-down direction, and the longitudinal channels 106 and the transverse channels are interlaced and communicated with each other. The first transverse channel 1041 is arranged in the gas storage space, the liquid outlet 103 is communicated with the fourth transverse channel 1044, a bypass outlet is opposite to the third channel 1043, and a connecting pipe is communicated with the throat section of the bypass member. One end of the connecting pipe is communicated with the throat section, and the other end of the connecting pipe extends to approach or access the gas storage space along one longitudinal channel.

The principle of increasing a gas-liquid contact area of the gas dissolution chamber 1 in embodiments of the present disclosure is as follows: the liquid enters through a liquid inlet, accelerates at the throat section 22 of the bypass member 2, and is injected into the gas dissolution chamber 1 through a gas-liquid premixing outlet. Due to the throttling effect of the bubbler 3 installed at the rear end of the liquid outlet 103, the internal pressure of the gas dissolution chamber 1 increases and the liquid level rises continuously. The gas in an upper part of the gas dissolution chamber 1 is compressed. Since a gas pressure in the gas storage space is greater than a liquid pressure at the throat section 22, the gas is sucked into the throat section 22 in the form of the Venturi tube to form a premix, and then injected into the gas dissolution chamber 1 through the gas-liquid premixing outlet. The bubble group expand in the third transverse channel 1043, and then the gas continuously rises and enters the gas storage space through the second transverse channel 1042 to form a gas circulation. Due to the existence of circulating bubbles, the gas-liquid contact area is increased and the gas dissolving efficiency is improved.

The bubble generating device 100 in embodiments of the present disclosure can be installed in a dishwasher and belongs to a microbubble generating device 100 with a water tank (gas dissolution chamber 1). The bubble generating device has a small thickness and can be installed in a narrow space, for example, inside an outer panel of the dishwasher. The bypass member 2 is provided for gas-liquid premixing to increase the gas-liquid contact area. In embodiments of the present disclosure, it is possible to realize pump-free microbubble washing through a water pressure of tap water, and utilize the microbubble generating device 100 by pressurized gas dissolving and throttling cavitation to generate micro-nano bubbles. By pressurized gas dissolving in the gas dissolution chamber 1, the concentration of microbubbles generated by throttling cavitation is increased, and the bubble size is small. The gas premixing is achieved by the bypass member 2. The passive gas intake structure is realized by gravity and through the venting valve 6. The gas utilization rate in the gas dissolution chamber 1 is increased by using the gas storage structure. The reinforcement structure (vertical reinforcing ribs in parallel and spaced apart from each other) of the gas dissolution chamber 1 prevents high pressure bursting. In addition, in an embodiment of the present disclosure, the direct-flushing water feeding entrains gas into the liquid surface, to increase the gas-liquid contact area. The venting valve 6 in embodiments of the present disclosure can be replaced with other types of valves, such as solenoid valves or the like, to realize ventilation and unidirectional gas intake by other control modes. In embodiments of the present disclosure, a gas pump can be added upstream the venting valve 6 in embodiments of the disclosure, and an active gas intake structure can be realized. With a liquid level sensor in the gas dissolution chamber 1, the continuous operation can be realized. In the process of drainage and gas intake, the gas pump can also be used to accelerate the drainage. In embodiments of the present disclosure, the microbubble generating device 100 by pressurized gas dissolving and throttling cavitation is used to generate micro-nano bubbles. By pressurized gas dissolving in the gas dissolution chamber 1, the concentration of microbubbles generated by throttling cavitation is increased, and the bubble size is small.

In conjunction with FIG. 10 to FIG. 15, embodiments of the present disclosure further provides a washing apparatus 1000, which can be a cleaning device such as a dishwasher.

The washing apparatus 1000 according to the embodiment of the present disclosure includes: a body 200 and a door. The body 200 has a washing cavity. The door is disposed on the body 200 and configured to open or close the washing cavity. A bubble generating device 100 is provided on at least one of a side wall of the body 200, a top wall of the body 200, a bottom wall of the body 200 and the door, and the bubble generating device 100 is the aforementioned bubble generating device 100.

With the washing apparatus 1000 according to the embodiment of the present disclosure, since the aforementioned bubble generating device 100 is provided, the liquid enters the bubble generating device 100 to generate microbubbles, and then the microbubbles participate in the washing process to improve the washing effect. The bubble generating device 100 in embodiments of the present disclosure can be arranged on a wall or door of the washing apparatus 1000, which can effectively simplify the structure and improve the space utilization rate.

In one embodiment, as shown in FIG. 15, the body 200 includes an inner tank 210 and a side plate 220. A side plate 220 is arranged on each of opposite sides of the inner tank 210, and the bubble generating device can be arranged between the side plate 220 and the inner tank 210. One or more bubble generating devices can be provided on the body 200.

In the description of the present disclosure, it is to be understood that terms “center”, “longitudinal”, “transverse”, “length”, “width”, “thickness”, “above”, “below”, “front”, “rear”, “left”, “right”, “vertical”, “horizontal”, “top”, “bottom”, “inner”, “outer”, “clockwise”, “counterclockwise”, “axial”, “radial”, “circumferential” should be construed to refer to the orientation or positional relationships as shown in the drawings, which are only for convenience of describing the present disclosure and simplifying the description, rather than indicating or implying that the devices or elements under discussion have a particular orientation or are constructed or operated in a particular orientation, and should not be construed to limit the present disclosure.

In addition, terms “first” and “second” are only used for purposes of description, and are not intended to indicate or imply relative importance or to imply the number of indicated features. Thus, the feature defined with “first” or “second” may expressly or implicitly include at least one of this feature. In the description of the present disclosure, “a plurality of” means at least two, for example, two, three, etc., unless specified otherwise.

In the present disclosure, unless specified or limited otherwise, the terms “mounted”, “connected”, “coupled”, “fixed” and the like are used broadly, and may be, for example, fixed connections, detachable connections, or integral connections; may also be mechanical or electrical connections; may also be direct connections or indirect connections via intervening structures; may also be inner communications of two elements or the interaction relationship between the two elements, unless specified otherwise. The specific meanings of the above terms in the present disclosure can be understood as they apply to embodiments of the disclosure.

In the present disclosure, unless specified or limited otherwise, a structure in which a first feature is “on” or “below” a second feature may include an embodiment in which the first feature is in direct contact with the second feature, and may also include an embodiment in which the first feature and the second feature are indirectly contacted via an intermediate structure. Furthermore, a first feature “on,” “above,” or “on top of” a second feature may include an embodiment in which the first feature is right or obliquely “on,” “above,” or “on top of” the second feature, or just means that the first feature is at a height higher than that of the second feature. While a first feature “below,” “under,” or “on bottom of” a second feature may include an embodiment in which the first feature is right or obliquely “below,” “under,” or “on bottom of” the second feature, or just means that the first feature is at a height lower than that of the second feature.

Reference throughout this specification to “an embodiment,” “some embodiments,” “an example,” “a specific example,” “some examples” or the like means that a particular feature, structure, material, or characteristic described in connection with the embodiment or example is included in at least one embodiment or example of the present disclosure. The appearances of the phrases in various places throughout this specification are not necessarily referring to the same embodiment or example. Furthermore, the described particular features, structures, materials, or characteristics may be combined in any suitable manner in one or more embodiments or examples. In addition, combination of different embodiments or examples and the features in different embodiments or examples described in this specification without being mutually contradicted.

1. A bubble generating device, comprising:
a gas dissolution chamber having a vent, a liquid inlet and a liquid outlet;
a bubbler connected to the liquid outlet; and
a bypass member having a convergent section, a throat section and a divergent section connected in sequence from a bypass inlet to a bypass outlet,
wherein the bypass inlet or the bypass outlet of the bypass member is communicated with the liquid inlet to supply a liquid into the gas dissolution chamber, and the throat section is communicated with the vent or a gas storage space in the gas dissolution chamber.

2. The bubble generating device of claim 1, wherein the throat section is communicated with the vent and the bypass outlet of the bypass member is communicated with the liquid inlet of the gas dissolution chamber to form a circulation loop.

3. The bubble generating device of claim 2, wherein at least a part of the gas dissolution chamber is a rotary housing, and the liquid inlet and the liquid outlet are both connected to the rotary housing.

4. The bubble generating device of claim 3, wherein the liquid inlet and the liquid outlet both extend away from the gas dissolution chamber in a clockwise direction or a counterclockwise direction of the rotary housing,
wherein an angle between a liquid feeding direction of the liquid inlet and a liquid discharging direction of the liquid outlet is not greater than 90°.

5. (canceled)

6. The bubble generating device of claim 3, wherein a first of the liquid inlet and the liquid outlet extends away from the gas dissolution chamber in a clockwise direction thereof, and a second of the liquid inlet and the liquid outlet extends away from the gas dissolution chamber in a counterclockwise direction thereof,
wherein an angle between a liquid feeding direction of the liquid inlet and a liquid discharging direction of the liquid outlet is greater than 90°, and wherein the angle between the liquid feeding direction of the liquid inlet and liquid discharging direction of the liquid outlet is in a range of 120° to 180°.

7-8. (canceled)

9. The bubble generating device according to claim 3, wherein the liquid inlet and the liquid outlet both extend in a tangential direction of the rotary housing.

10. The bubble generating device according to claim 1, wherein the vent is arranged at a top of the gas dissolution chamber, and the liquid inlet and the liquid outlet are arranged at a lower part of the gas dissolution chamber.

11. The bubble generating device according to claim 1, wherein
the lower part of the gas dissolution chamber is in a shape of a barrel;
an upper part of the gas dissolution chamber is in a shape that gradually shrinks in a bottom-up direction;
the liquid inlet and the liquid outlet are arranged on opposite sides of a plane passing through a centerline of the gas dissolution chamber;
the liquid inlet and the liquid outlet are respectively arranged at different walls of the gas dissolution chamber;
the liquid inlet is higher than the liquid outlet.

12. (canceled)

13. The bubble generating device according to claim 1, wherein the bypass member is arranged in the gas dissolution chamber, and the bypass inlet is communicated with the liquid inlet, the bypass outlet is communicated with an inner space of the gas dissolution chamber, and the throat section is communicated with the gas storage space.

14. The bubble generating device of claim 13, wherein
the gas storage space is arranged at a top of the gas dissolution chamber;
a horizontal cross-sectional area of the gas storage space is less than a horizontal cross-sectional area of a space below the gas storage space; and
the bypass member is arranged in a lower part of the gas dissolution chamber, a connecting pipe is connected and communicated with the throat section of the bypass member, and extends upward to approach or access the gas storage space.

15. The bubble generating device of claim 13, wherein a reinforcing rib is arranged in the gas dissolution chamber, and divides the gas dissolution chamber into a plurality of transverse channels communicated with each other, the transverse channels extend in a horizontal direction, and the plurality of transverse channels are sequentially arranged in an up-down direction.

16. The bubble generating device of claim 15, wherein the plurality of transverse channels comprise a first transverse channel, a second transverse channel, a third transverse channel, and a fourth transverse channel in a top-down direction, wherein the first transverse channel is located in the gas storage space, the liquid is supplied from the liquid inlet to the third transverse channel, and the liquid outlet is communicated with the fourth transverse channel.

17. The bubble generating device of claim 16, wherein the bypass outlet is opposite to the third transverse channel, and a liquid discharging direction of the bypass outlet is parallel to an extension direction of the third transverse channel.

18. The bubble generating device according to claim 16, wherein
the vent is positioned near the first transverse channel; and
a distance between the second transverse channel and the third transverse channel is greater than that between the first transverse channel and the second transverse channel, and greater than that between the third transverse channel and the fourth transverse channel; and
the liquid outlet is arranged at a bottom wall of the fourth transverse channel.

19. The bubble generating device of claim 15, wherein the gas dissolution chamber is divided into a plurality of longitudinal channels by the reinforcing rib, the plurality of longitudinal channels are arranged at intervals in a horizontal direction, extend in an up-down direction and intersect the transverse channels in the up-down direction, and the plurality of the longitudinal channels and the plurality of the transverse channels are interlaced and communicated with each other.

20. (canceled)

21. The bubble generating device according to claim 1, wherein
the gas dissolution chamber is in a flat shape; and
wall thickness of the gas dissolution chamber is in a range of 2 mm to 5 mm.

22. The bubble generating device according to claim 1, wherein the gas dissolution chamber comprises a first shell and a second shell fastened and fixedly connected to each other.

23. The bubble generating device of claim 22, wherein
bumps are respectively provided at a periphery of the first shell and a periphery of the second shell, and the bumps on the first shell are correspondingly connected with the bumps on the second shell to connect the periphery of the first shell with the periphery of the second shell; and
a fixing block is arranged in a middle of the gas dissolution chamber, and configured for fixing piece connection to connect a middle of the first shell with a middle of the second shell.

24. A washing apparatus, comprising:
the bubble generating device, comprising:
a gas dissolution changer having a vent, a liquid inlet and a liquid outlet;
a bubbler connected to the liquid outlet;
a bypass member having a convergent section, a throat section and a divergent section connected in sequence from a bypass inlet to a bypass outlet,
wherein the bypass inlet of the bypass outlet of the bypass member is communicated with the liquid inlet to supply a liquid into the gas dissolution chamber, and the throat section is communicated with the bent or a gas storage space in the gas dissolution chamber.

25. The washing apparatus of claim 24, wherein the washing apparatus further comprises:
a body with a washing cavity therein;
a door disposed on the body and configured to open or close the washing cavity;
wherein the bubble generating device is provided on at least one of a side wall of the body, a top wall of the body, a bottom wall of the body and the door.
